(19) United States
(12) Patent Application Publication
(10) Pub. No.: US 2014/0378221 A1
(43) Pub. Date: Dec. 25, 2014

(54) Gaming Machine, Video Controller and Method for Arranging and Scaling Native and Legacy Video Content to Fit a Large Format Primary Display

(71) Applicant: BALLY GAMING, INC., Las Vegas, NV (US)

(72) Inventor: Vernon Bernard, Las Vegas, NV (US)

(21) Appl. No.: 14/297,986

(22) Filed: Jun. 6, 2014

Related U.S. Application Data
(60) Provisional application No. 61/838,719, filed on Jun. 24, 2013.

(51) Int. Cl. G07F 17/32

(52) U.S. Cl. CPC G07F 17/3211
USPC 463/31

(57) ABSTRACT

A gaming device, video controller and method which are configured to port video content designed for display on plural video displays to large format video displays. In an embodiment the gaming device, method and video controller detects a single or plural video input connections as providing either native content developed for large format displays or legacy content designed for plural displays and blocks, scales and configures the content to fit the larger size video display.

### CROSS REFERENCE TO RELATED APPLICATIONS

This application is a non-provisional application that claims priority to Provisional Application No. 61/838,719 filed Jun. 24, 2013.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The field of the invention relates to gaming machines, video controllers and methods which are adapted to scale and arrange video content to fit into a large format display such as a gaming machine display arranged in a portrait mode.

2. Background

Various types of gaming machines have been developed with features designed to captivate and maintain player interest. In general, a gaming machine allows a player to play a game of chance in exchange for a wager. Depending on the outcome of the game, the player may be entitled to an award which is paid to the player by the gaming machine, normally in the form of currency or game credits. Gaming machines may include flashing displays, lighted displays or sound effects to capture a player's interest in a gaming device.

Many modern gaming machines include several video displays: a primary game display for displaying primary game content and one or more secondary displays arranged above or below the primary game display on a game cabinet. FIG. 1 illustrates such a type of modern gaming machine with the aforesaid plural video displays. These displays, referred to herein as legacy video displays or legacy displays, display primary game content as well as bonus or feature games and game related information and graphics. In most instances the at least the primary game display will include touch screen interface functionality.

It is also known that such types of gaming machines may include a touch screen display button panel located below the primary game display offering button selections and game related content. Such a touch screen button panel is disclosed in Kelly, et al, US Pub App 2012/0108337 filed Oct. 31, 2011 and titled “Gesture Enhanced Input Device” the disclosure of which is incorporated by reference.

The venues hosting such gaming machines such as casinos also include systems which provide for monitoring the operation and performance of the gaming machines on the network, enabling tracking of player interaction with the gaming machine and for downloading content and functionality to the gaming machines and their components. A casino enterprise typically includes a communication network by which an operator can monitor player activity such as wagers, jackpots, games played and the like on the gaming machines in the network. Players are identified typically thought the player's use of a loyalty card having a machine readable stripe. For a brick and mortar casino an example of such a system is the Bally CMS® system sold by Bally Technologies, Inc. of Las Vegas, Nev. These systems interface with card readers at gaming terminals and table game input devices to provide the aforesaid tracking functions. Based upon the data collected the casino can provide bonuses to players in the way of benefits and incentives to retain a player's loyalty by, for example, awarding “comps” in the form of cash back, discounts for goods, lodging, services and gifts or points which can be exchanged for the foregoing. The tracking can be restricted to a single enterprise venue or can be on a national basis such as described in Boushy, U.S. Pat. No. 7,419,427 issued Sep. 2, 2008 and titled “National Customer Recognition System and Method”, the disclosure of which is incorporated by reference. The level of “comps” available to the player is related to the player's rating which acts to quantify the value of the player to the casino. A higher rated player is one who spends and gambles more than a lower rated player. A higher rated player is entitled to more valuable or additional comps.

In regards to casino enterprise systems it has also been known to provide at a gaming machine an interface through which the player may interact with the system such as receiving information about their account, advertising as well as downloading comp related data such as promotional money for gaming. In the past this system interface included a separate display often mounted on the gaming machine proximate a card reader. It is also now known to, instead of delivering system content to separate, small display, to display the information at the gaming machine primary display in a display window which may be closed or called up by the player. This feature is disclosed in Kelly, et al, U.S. Pat. No. 8,241,123 issued Aug. 14, 2012 the disclosure of which is incorporated by reference. Player information as well as system provided bonus and secondary games can be delivered to the display window for player interaction.

Returning to prior gaming machine of the type shown in FIG. 1, manufacturers and other content providers have developed large libraries of the legacy display content. This video game content is constructed to be delivered to the plural displays by the game CPU. The game CPU alone or in combination with other processors has a video output to each display for delivering the designed video content thereto.

Recently gaming machines with large format primary video displays have been developed. This large video display may be flat, 40 inch video displays turned into the portrait mode (vertical dimension greater than width dimension) of the type disclosed in Mitchell, U.S. Pat. No. 8,002,637 titled “Method for Retrofitting an Extended Display Device to an Existing Gaming Machine Assembly”, issued Aug. 23, 2011 the disclosure of which is incorporated by reference. Extended curved displays also in the portrait mode have also been disclosed such as in Wudtke, U.S. Ser. No. 29/432,565 titled “Gaming Machine Cabinet” and Kelly et al, U.S. Pub. App. 2012/004030 titled “Video Terminal Having a Curved, Unified Display” filed Jun. 30, 2010 the disclosures of which are incorporated by reference. To provide content to these larger format displays native, i.e. original, content is developed. This native content is specifically crafted for presentation on the large format video displays.

While the large format displays provide a desirable presentation to the player and in the casino, legacy content cannot be easily migrated to these displays. Thus, if a game manufacturer has popular legacy game video game content originally designed for presentation on multiple video displays, the content must be re-cast and re-worked into a large display format. The re-working consumes development resources. It would be desirable to provide an apparatus and method whereby a large format display could accommodate both native and legacy video content to scale and size the same and where necessary create a mosaic of the legacy content to fit and be presented in a large format display. In this regard it would be advantageous to scale and arrange the legacy graphics such that the primary game content is positioned in the correct, designated region of the large format display to accommodate the touch screen functionality at the display.

The foregoing examples of the related art and limitations related therewith are intended to be illustrative and not exclusive. Other limitations of the related art will become apparent to those of skill in the art upon a reading of the specification and a study of the drawings. Additionally, limitations and disadvantages of the related art may become apparent from review of other related art itself.

### SUMMARY OF THE INVENTION

There is, therefore, set forth according to the present invention, there is set forth a gaming machine and video controller which is adapted to at least scale video content for presentation at large format video displays. There is also set forth a gaming machine and video controller which is adapted to receive legacy video content developed for presentation at plural video displays and to scale and arrange the legacy content into a presentation mosaic for display at a large format video display.

In an embodiment there is set forth gaming machine having a large format primary video display for displaying (i) native video content configured to be presented at said primary video display and (ii) legacy video content scaled to be cooperatively presented at plural legacy video displays of sizes different than said primary display. The gaming machine includes a processor to process software defining at least one of native video content for display at the primary video display and legacy video content for display at plural legacy displays. The processor has multiple outputs each configured to provide video content to a legacy video display.

The video controller includes plural input connections from the processor and an output connection to the large format primary video display. The video controller is configured to interpret plural input connections as providing legacy video content and to at least scale the legacy content to create a legacy content mosaic to fit the legacy content to said primary video display.

To create the mosaic the video controller may block, rotate, scale and nest said legacy video content to create the mosaic.

In an embodiment an input of the video controller is designated as a primary input configured to receive the primary game output from the game processor and thus position the primary game content in a desired position in the mosaic and large format primary video display.

In an embodiment there is set forth method for providing one of natively developed game video content and legacy game video content at a gaming machine large format primary video display where said legacy game content is configured to provide game content graphics to a legacy primary video display and separate legacy secondary video display and where the legacy video displays are smaller than the primary video display. The method includes providing a video controller for receiving at one or plural input ports video content signals from a game processor and for delivering video content signals to said primary video display, interpreting graphic content signals delivered at plural input ports as representing legacy primary and secondary video content. The method further includes at least scaling the legacy primary and secondary video content to define a mosaic of adjacent legacy primary and secondary video content to fit into the large format primary video display.

There is also set forth video controller for a gaming machine having (a) a primary video display for displaying (i) native video content configured to be presented at primary video display and (ii) legacy video content scaled to be cooperatively presented at plural legacy video displays of sizes different than the primary display. A processor controls the rendering of the video content and has plural outputs for providing the rendered video content to a display for presentation thereof. The video controller includes plural inputs each for receiving an output from the processor. A controller is programmed for interpreting a singular input connection as providing native video content configured for display at said primary display and plural input connections as providing legacy video content fashioned for display at plural display. The controller is programmed to, upon interpreting the inputs as legacy video content, scale and arranges the legacy video content to define a mosaic of the legacy content to fit into the primary video display.

Other features and advantages will become evident upon review of the following description and drawings.

### BRIEF DESCRIPTION OF THE DRAWINGS

FIG. 1 illustrates a legacy gaming device according to the prior art;

FIGS. 2A-2B illustrate an example of a gaming device operational platform and components for a gaming terminal of the type of the present invention;

FIG. 3 is a block diagram of the logical components of a gaming kernel for a gaming device.

FIGS. 4A and 4B is a schematic of an example of a casino enterprise network incorporating gaming devices;

FIG. 5A is a perspective view of a gaming device including a large format, curved primary game display;

FIG. 5B is a front view of the gaming device of FIG. 5A;

FIGS. 6A and B show embodiments of gaming terminals having large format, flat screen, primary game displays;

FIG. 7 is a diagram illustrating the game processor CPU output of legacy video content signals to plural displays according to the prior art;

FIG. 8 is a diagram illustrating the outputs from the game CPU to the video controller of the present invention and the output from the video controller to a large format video display;

FIG. 9 illustrates the receipt, blocking, rotating and scaling of legacy video content created for display at three video displays to create a mosaic to fit on and be displayed by a singular large format video display;

FIG. 10 illustrates the receipt and scaling (if necessary) of native video content to fit on and be displayed by the large format video display;

FIG. 11 is a diagram illustrating the placing of the legacy video content blocks into a large format video display; and

FIG. 12 is a logic diagram for the operation of the video controller.

### DETAILED DESCRIPTION

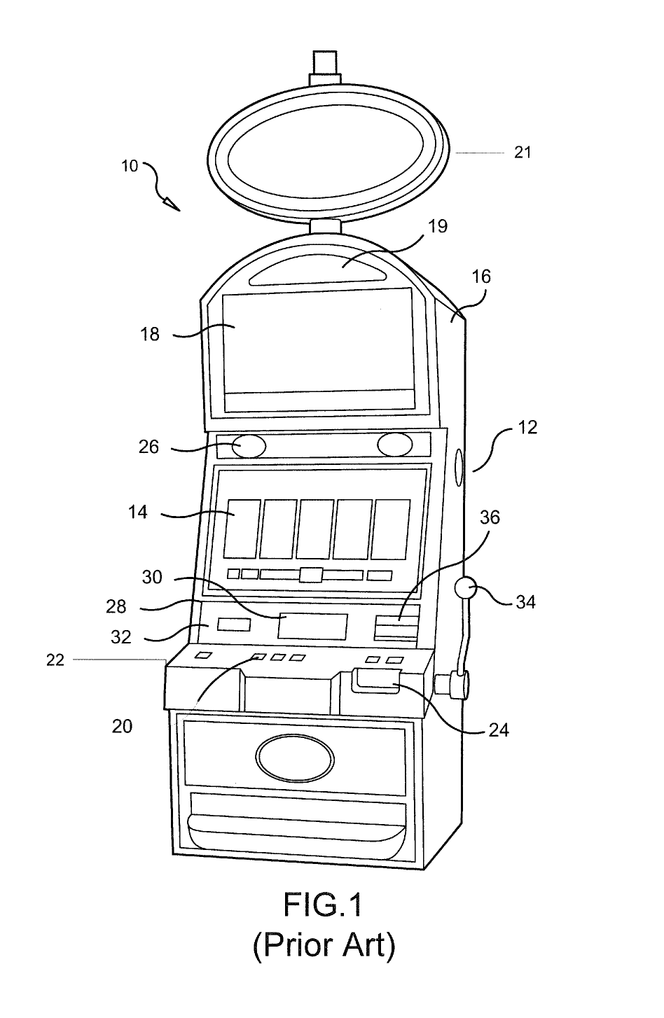

Referring now to the drawings, wherein like reference numbers denote like or corresponding elements throughout the drawings, and more particularly referring to FIG. 1, a gaming device 10 according to the prior art is shown. The gaming device 10 includes cabinet 12 providing an enclosure for the several components of the gaming device 10 and associated equipment. A legacy primary game display 14 is mounted to the cabinet 12. The legacy primary game display 14 may be a video display such as an LCD, plasma, OLED or other electronic display as are known in the art. The legacy primary game display 14 may also be embodied as a combination of two or more electronic displays disposed in an adjacent overlapping or overlying arrangement. The legacy primary game display 14 may be mounted to one or more of a door for the cabinet 12 or the cabinet chassis itself. The legacy primary game display 14 is located to display game video content (and if desired other content) to the player. For example, the game video content may be base game outcomes presented by a plurality of video spinning reels displaying symbols the combinations of which define winning or losing outcomes, video Poker, Keno or other form of base casino wagering game as is known in the art. While the following description of the various embodiments of the present invention is directed to video reel-spinning games, it should be understood that the invention could be applied to other games as well. Where the legacy primary game display 14 is a video display, features such as bonus/feature games may also be presented s hereinafter described. The foregoing description should not be deemed as limiting the content (graphics, video or text) which can be displayed at the legacy primary game display 14. Touch screen input functionality may be associated with the legacy primary game display to enable the player to interact with the video content such as the game.

The gaming device 10 also includes in one or more embodiments a top box 16 which may support a printed back-lit glass (not shown) as is known in the art depicting the rules, award schedule, attract graphics or it may support a legacy secondary game display 18 which may be of one of the types described above with reference to the legacy primary game display 14. The top box 16 may also support a backlit glass with graphics defining a marquee 19 and a topper 21 including additional graphics. These legacy video displays such as the legacy primary video display 14 and legacy secondary video display 18 may be standard 17 or 19 inch CRT or flat panel video displays.

While the gaming device 10 described above includes only two legacy video displays it should be understood that some gaming devices have three or more. For example the topper 21 could include or be replaced by a third legacy video display.

To enable a player to provide input to the controller for the gaming device 10 a plurality of buttons 20 may be provided on a button deck 22 for the gaming device 10. Additionally and alternatively one or both of the primary and secondary game displays 14, 18 may include touch screen input interface(s) as are known in the art. Most typically inasmuch as the legacy primary game display 14 is positioned nearer the player and in a position for player touch interaction, only the legacy primary legacy display 14 has touch screen functionality.

Video content for display at the legacy primary and secondary displays 14, 18 is crafted by designers to be adapted for display at one or more of the displays. For example, a video spinning real slot machine game and bonus and secondary features are designed to be displayed solely at the legacy primary game display for play and interaction by the player. Meters (credit and win meters) are also typically displayed at the legacy primary display as well has other icons such as a “Help Screen” call-up icon and touch enabled icons to, for example, select pay lines to play and wagers per selected pay line. Video content for the legacy secondary display 18 may include, by way of example only, video content to identify the game, animated of video content to attract players to the game, the game pay table (as well as highlighting wins on the pay table as they occur, progressive jackpot information or the like. It has been known to, in features triggered from the base game, to simultaneously display cooperative video content on both of the legacy primary and secondary displays 14, 18. It should be understood that for gaming devices 10, for the most part, the video content for the legacy primary and secondary displays 14, 18 is related (since there is a common game theme presentation) but is different.

Buttons, selections or inputs are displayed at the legacy primary game displays 14 and the player touching those icons or designated areas provides the required or desired input to configure and play the gaming device 10. The buttons 20 may be displayed and defined at a touch screen button panel interface of the type described in Kelly et al U.S. Pub. 2010/0113140A1 filed Nov. 16, 2009 and titled “Gesture Enhanced Input Device”, the disclosure of which is incorporated herein. Where a touch screen button panel interface is used, it may also be considered to be one of the plural displays according to the present invention as described below. The touch screen button panel includes its video display which is smaller than the legacy primary game display 14.

Other peripherals or associated equipment for the gaming device 10 include a bill/voucher acceptor 24 which reads and validates currency and vouchers for the player to establish credits for gaming on the gaming device 10 and one or more speakers 26 to provide audio to the player in association with the game play. To provide for communication between the gaming device 10 and a casino system, a player tracking module (PTM) 28 is mounted on the cabinet 12. PTM 28 has a PTM display 30 to display system related information to the player. The PTM display 30 may be a small LCD, plasma or OLED display with touch screen functionality. In an embodiment the community games and features described herein are displayed at the PTM display 30; however, as set forth below these presentations are preferably migrated to areas at the primary or secondary displays 14, 18. A card reader 32 is provided to read a machine readable component on a player loyalty card issued to the player to identify the player to the casino system as in known in the art. A ticket printer 36 may be provided as well on the PTM 28 or elsewhere on the gaming device 10 to provide printed value ticket vouchers to players as is known in the art.

Some functionality of the PTM 28 may be provided by a video switcher and touch router device as is described in U.S. Pub. App. 2009/0149253 entitled “Video Switcher and Touch Router Method for a Gaming Machine” filed Jan. 8, 2009 and incorporated by reference. System and externally based content including the community game presentations, player information, advertisements or other information may be displayed at areas at one or more of the legacy primary or secondary displays 14, 18 dispensing with the need for the separate PTM display 30. According to the disclosure of U.S. Pub. App. 2009/0149253 when system content as well as the community game(s) described herein are presented at the legacy primary game display 14, the presentation of the base game played by the player is sized to share display real estate with the system content and/or community game as hereinafter described. The touch screen interface is also configured to interpret input “touches” from a player as relating to the base game content or the systems based content sharing the legacy primary game real estate.

While the player may use the buttons 20 to prompt play of the game (or the touch screen input), alternatively the player may use a handle 34 to prompt an input as is known in the art.

Cabinet 12 may be a self-standing unit that is generally rectangular in shape and may be manufactured with reinforced steel or other rigid materials which are resistant to tampering and vandalism. Any shaped cabinet may be implemented with any embodiment of gaming device 10 so long as it provides access to a player for playing a game. For example, cabinet 12 may comprise a slant-top, bar-top, or table-top style cabinet, including a Bally Cinevision™ or CineReels™ cabinet. The gaming device 10 may include a controller and memory disposed within the cabinet 12 or may have thin client capability such as that some of the computing capability is maintained at a remote server.

The plurality of player-activated buttons at the button deck 22 may be used for various functions such as, but not limited to, selecting a wager denomination, selecting a game to be played, selecting a wager amount per game, initiating a game, or cashing out money from gaming machine 10. Buttons may be operable as input mechanisms and may include mechanical buttons, electromechanical buttons or touch screen buttons. In one or more embodiments, buttons may be replaced with various other input mechanisms known in the art such as, but not limited to, touch screens, touch pad, track ball, mouse, switches, toggle switches, or other input means used to accept player input. For example, one input means is as disclosed in U.S. Pub. App. 2011/0111853, entitled “Universal Button Module,” filed on Jan. 14, 2011 and/or U.S. Pub. App. 2010/0113140 entitled “Gesture Enhanced Input Device” filed Nov. 16, 2009 which are hereby incorporated by reference. Player input may also be by providing touch screen functionality at the legacy primary game display 14 and/or secondary game display 18.

The legacy primary game display 14, according to the present invention, is controlled to present at least one instance of a base game of chance wherein a player receives one or more outcomes from a set of potential outcomes. For example, one such game of chance is a video slot machine game. In other aspects of the invention, gaming machine 10 may present a video slot machine, a video keno game, a lottery game, a bingo game, a Class II bingo game, a roulette game, a craps game, a blackjack game, a mechanical or video representation of a wheel game or the like. As more fully described below the legacy primary game display 14 may be controlled to present and play multiple instances of concurrent games.

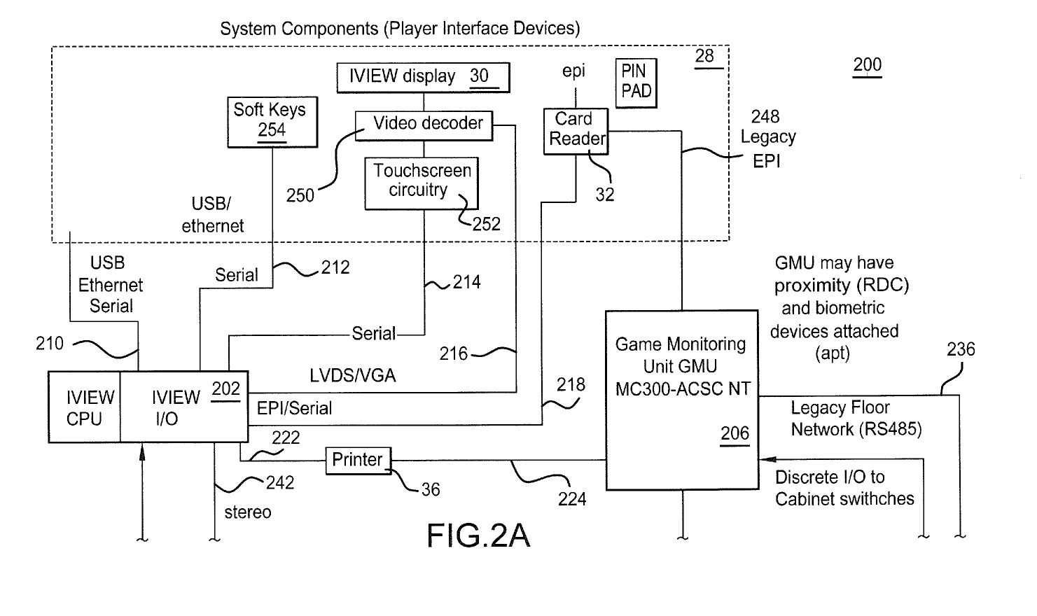

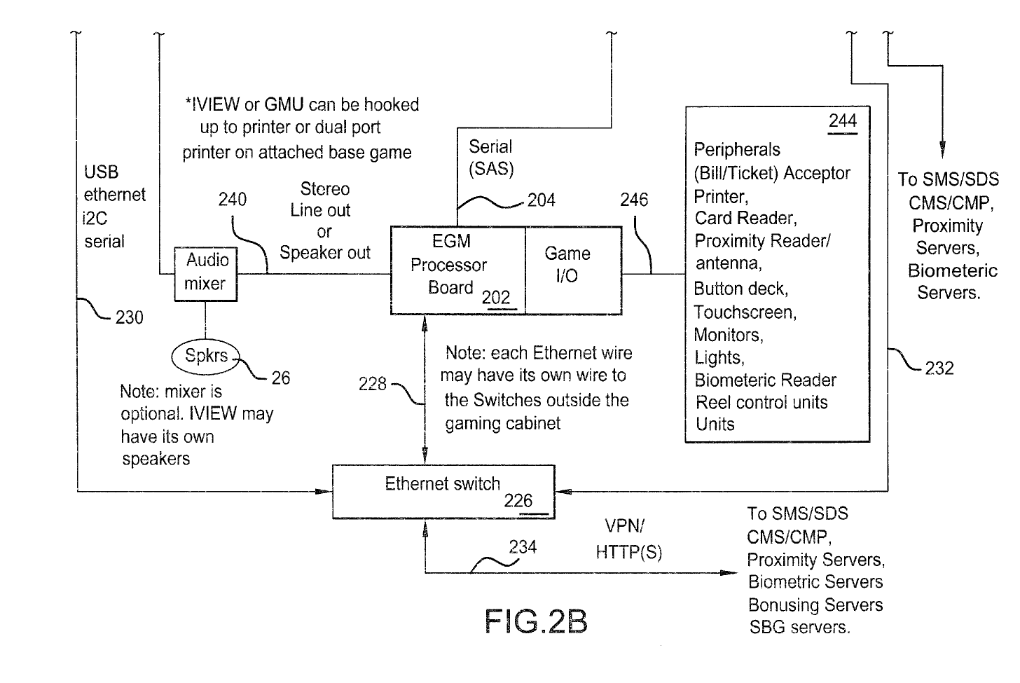

Referring to FIGS. 2A, B, the gaming device 10 hardware 200 for the controller(s) is shown in accordance with one or more embodiments. The hardware 200 may be applicable to the prior art gaming device 10 as well as a gaming device according to the present invention. The hardware 200 includes game processor board 202 (EGM Processor Board), sometimes referred to herein as the game CPU, connected through serial bus line 204 to game monitoring unit (GMU) 206 (such as a Bally MC300 or ACSC NT manufactured and sold by Bally Gaming, Inc., Las Vegas, Nev.), and player interface CPU/input-output device 202 (CPU 202) connected to the player tracking module (PTM) 28 over bus lines 210, 212, 214, 216, 218. The game processor board 202 includes one or more processors and memory devices for the control of inputs and outputs to operate the game. At least one processor is configured to access one or memory devices to control the video content displayed at the plural displays such as the legacy primary and secondary displays 14, 18. The at least one processor, as described below, has plural outputs each defining a video output to a designated one of the legacy primary game display 14 and legacy secondary display 18. Typically these outputs are suitable wired and plug in connections. Thus, content intended for the legacy primary game display 14 (primary game video content) is directed to a primary output and content intended for the legacy secondary display 18 is directed to a secondary output.

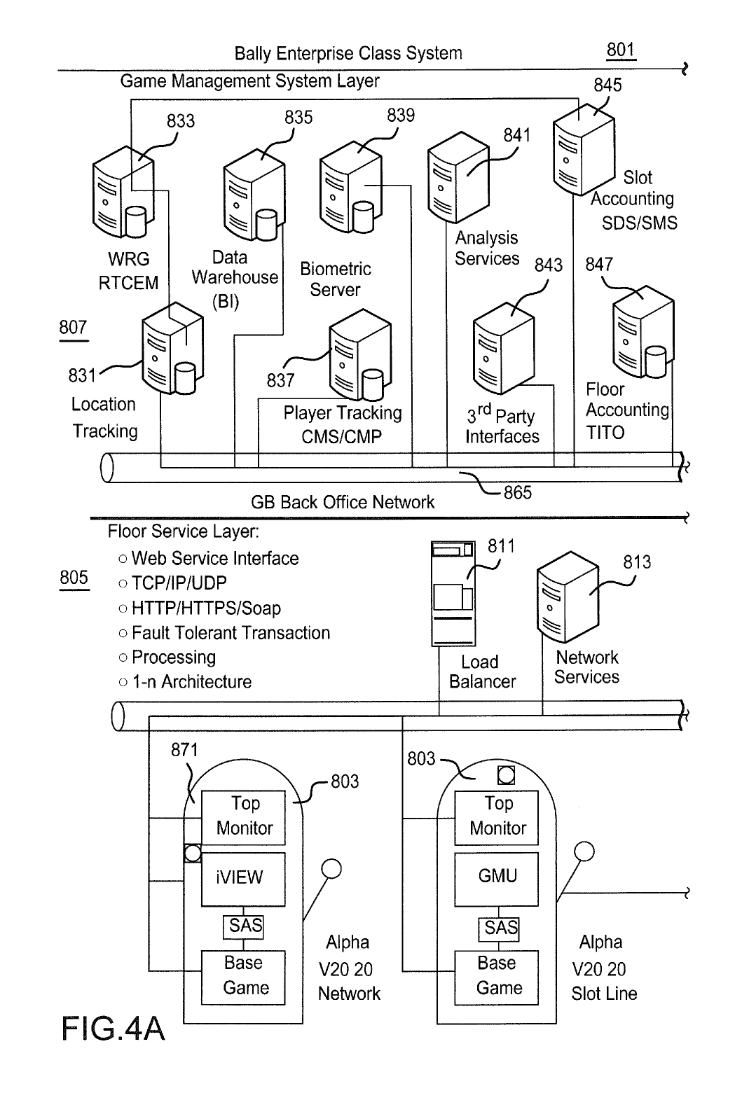

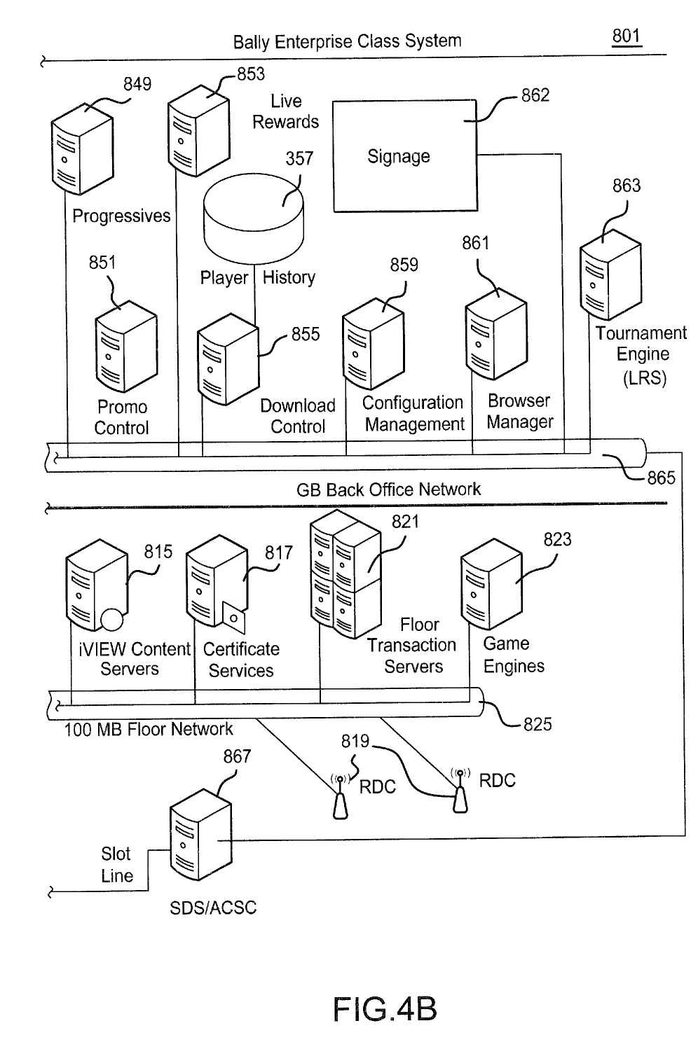

The PTM 28 provides for communication between one or more gaming devices 10 and the casino system such as the type as hereinafter described. Inasmuch as gaming devices 10 may be manufactured by different entities, mounting like PTMs 28 at each gaming device 10 provides for communication to the system in one or more common message protocols. Typically when a casino enterprise purchases a casino management system they also purchase the same manufacturer's PTMs 28 and video switcher and touch router such as a DM (display manager) device or the type sold by Bally Gaming, Inc. of Las Vegas, Nev. which are then installed by the various manufacturers of the gaming devices for the enterprise before delivery. In this manner the mountings for the PTMs 28 on the gaming devices can be configured for location and esthetic appearance. Gaming voucher ticket printer 36 (for printing player cash out tickets) is connected to PIB 208 and GMU 206 over bus lines 222, 224. EGM Processor Board 202, CPU 202, and GMU 206 connect to Ethernet switch 226 over bus lines 228, 230, 232. Ethernet switch 226 connects to a slot management system and a casino management system (SMS, SDS, CMS and CMP) (FIGS. 4A, 4B) network over bus line 234. Ethernet switch 226 may also connect to a server based gaming server or a downloadable gaming server. GMU 206 also may connect to the network over bus line 236. Speakers 26 to produce sounds related to the game or according to the present invention connect through audio mixer and bus lines 240, 242 to EGM Processor Board 202 and PIB 208.

Peripherals 244 connect through bus 246 to EGM Processor Board 202. The peripherals 244 include, but are not limited to the following and may include individual processing capability: bill/voucher acceptor 24 to validate and accept currency and ticket vouchers, the player interfaces such a buttons 20. The peripherals 244 may include the legacy primary game display 14, secondary game display 18 and other displays such as, for example a tertiary video display or touch screen button panel video display as described above. The bill/voucher acceptor 24 is typically connected to the game input-output board of the EGM processing board 202 (which is, in turn, connected to a conventional central processing unit (“CPU”) board), such as an Intel Pentium® microprocessor mounted on a gaming motherboard. The I/O board may be connected to CPU processor board by a serial connection such as RS-232 or USB or may be attached to the processor by a bus such as, but not limited to, an ISA bus. The I/O board and/or EGM processing board 202 include outputs for directing processed video content output to the correct display. Intervening graphics processing may also be included. Again these outputs are typically suitable wired connections. The gaming motherboard may be mounted with other conventional components, such as are found on conventional personal computer motherboards, and loaded with a game program which may include a gaming machine operating system (OS), such as a Bally Alpha OS. EGM processor board 202 executes a game program that causes the gaming device 10 to display at the plural displays and play a game. The various components and included devices may be installed with conventionally and/or commercially available components, devices, and circuitry into a conventional and/or commercially available gaming terminal cabinet 12.

When a player has inserted a form of currency such as, for example and without limitation, paper currency, coins or tokens, cashless tickets or vouchers, electronic funds transfers or the like into the currency acceptor, a signal is sent by way of bus 246 to the I/O board and to EGM processor board 202 which, in turn, assigns an appropriate number of credits for play in accordance with the game program. The player may further control the operation of the gaming machine by way of other peripherals 244, for example, to select the amount to wager via the buttons 20. The game starts in response to the player operating a start mechanism such as the handle 34, button 20 such as a SPIN/RESET button or a touch screen icon. The game program includes a random number generator to provide and display randomly selected video indicia at the legacy primary game display 14 as shown in FIG. 1. In some embodiments, the random generator may be physically separate from gaming device 10; for example, it may be part of a central determination host system which provides random game outcomes to the game program. Finally, EGM processor board 202 under control of the game program and OS compares the outcome to an award schedule. The set of possible game outcomes may include a subset of outcomes related to the triggering and play of a feature or bonus game. In the event the displayed outcome is a member of this subset, EGM processor board 202, under control of the game program and by way of I/O Board, may cause feature game play to be presented on the legacy primary game display 14 and/or any legacy secondary display(s) 18.

Video content and predetermined payout amounts for certain outcomes, including feature game outcomes, are stored as part of the game program. Such payout amounts are, in response to instructions from processor board 202, provided to the player in the form of coins, credits or currency via I/O board and a pay mechanism, which may be one or more of a credit meter, a coin hopper, a voucher printer, an electronic funds transfer protocol or any other payout means known or developed in the art.

In various embodiments, game programs (including video content for the plural displays) are stored in a memory device (not shown) connected to or mounted on the gaming motherboard. By way of example, but not by limitation, such memory devices include external memory devices, hard drives, CD-ROMs, DVDs, and flash memory cards. In an alternative embodiment, the game programs are stored in a remote storage device. In an embodiment, the remote storage device is housed in a remote server such as a downloadable gaming server. The gaming device may access the remote storage device via a network connection, including but not limited to, a local area network connection, a TCP/IP connection, a wireless connection, or any other means for operatively networking components together. Optionally, other data including graphics, sound files and other media data for use with the gaming device are stored in the same or a separate memory device (not shown). Some or all of the game programs and its associated data may be loaded from one memory device into another, for example, from flash memory to random access memory (RAM).

In one or more embodiments, peripherals may be connected to the system over Ethernet connections directly to the appropriate server or tied to the system controller inside the gaming terminal using USB, serial or Ethernet connections. Each of the respective devices may have upgrades to their firmware utilizing these connections.

GMU 206 (Game Monitoring Unit) includes an integrated circuit board and GMU processor and memory including coding for network communications, such as the G2S (game-to-system) protocol from the Gaming Standards Association, Las Vegas, Nev., used for system communications over the network. As shown, GMU 206 may connect to the card reader 32 through bus 248 and may thereby obtain player information and transmit the information over the network through bus 236. Gaming activity information may be transferred by the EGM Processor Board 202 to GMU 206 where the information may be translated into a network protocol, such as S2S, for transmission to a server, such as a player tracking server, where information about a player's playing activity may be stored in a designated server database.

PIB 208 includes an integrated circuit board, PID processor, and memory which includes an operating system, such as Windows CE, a player interface program which may be executable by the PID 208 processor together with various input/output (I/O) drivers for respective devices which connect to PID 208, such as player tracking module 28, and which may further include various games or game components playable on PID 208 or playable on a connected network server and PID 208 is operable as the player interface. PID 208 connects to card reader 32 through bus 218, player tracking display 30 through video decoder 250 and bus 216, such as an LVDS or VGA bus.

As part of its programming, the PID 208 processor executes coding to drive player tracking display 30 and provide messages and information to a player. Touch screen circuitry 252 interactively connects PTM display 30 and video decoder 250 to PID 208 such that a player may input information and causes the information to be transmitted to PID 208 either on the player's initiative or responsive to a query by PID 208. Additionally soft keys 254 connect through bus 212 to PID 208 and operate together with the player tracking display 30 to provide information or queries to a player and receive responses or queries from the player. PID 208, in turn, communicates over the CMS/SMS network through Ethernet switch 226 and busses 230, 234 and with respective servers, such as a player tracking server.

PTMs 28 are linked into the virtual private network of the system components in gaming device 10. The system components include the player tacking module 28 (e.g. Bally iVIEW ® device) (‘iView” is a registered trademark of Bally Gaming, Inc.) processing board 202 and game monitoring unit (GMU) processing board 202. These system components may connect over a network to the slot management system (such as a commercially available Bally SDS/SMS) and/or casino management system (such as a commercially available Bally CMP/CMS).

The GMU 206 system component has a connection to the base game through a serial SAS connection and is connected to various servers using, for example, HTTPs over Ethernet. Through this connection, firmware, media, operating system software, gaming machine configurations can be downloaded to the system components from the servers. This data is authenticated prior to installation on the system components.

The system components include the PTM 28 processing board and game monitoring unit (GMU) 206. The GMU 206 and PTM 28 can be combined into one like the commercially available Bally GTM iVIEW device. This device may have a video mixing technology to mix the EGM processor's video signals with the iVIEW display onto the top box monitor or any monitor on the gaming device.

The PTM 28 may also interface with a switcher and router device of the type described in U.S. Pub. App. 2009/0149253 entitled “Video Switcher and Touch Router Method for a Gaming Machine” filed Jan. 8, 2009 and incorporated by reference. Instead of providing the PTM display 30, the switcher and router device (e.g. DM) provides for the content normally display at the PTM display 30 to be displayed at and share display real estate with one or more of the legacy primary or secondary displays 14, 18.

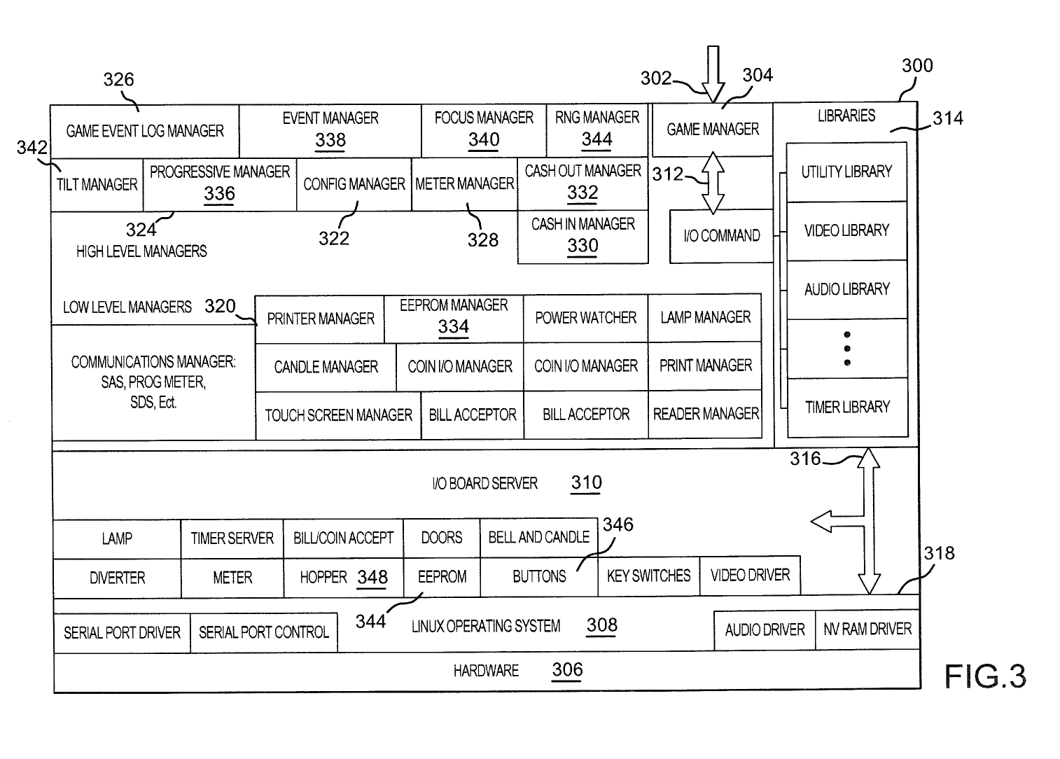

In accordance with one or more embodiments, FIG. 3 is a functional block diagram of a gaming kernel 300 of a game program under control of gaming terminal processor board 202. The game program uses gaming kernel 300 by calling into application programming interface (API) 302, which is part of game manager 304. The components of game kernel 300 as shown in FIG. 3 are only illustrative, and should not be considered limiting. For example, the number of managers may be changed, additional managers may be added or some managers may be removed without deviating from the scope and spirit of the invention.

As shown in the example, there are three layers: a hardware layer 306; an operating system layer 308, such as, but not limited to, Linux; and a game kernel layer having game manager 304 therein. In one or more embodiments, the use of an operating system layer 308, such a UNIX-based or Windows-based operating system, allows game developers interfacing to the gaming kernel to use any of a number of standard development tools and environments available for the operating systems. This is in contrast to the use of proprietary, low level interfaces which may require significant time and engineering investments for each game upgrade, hardware upgrade, or feature upgrade. The game kernel 300 executes at the user level of the operating system layer 308, and itself contains a major component called the I/O board server 310. To properly set the bounds of game application software (making integrity checking easier), all game applications interact with gaming kernel 300 using a single API 302 in game manager 304. This enables game applications to make use of a well-defined, consistent interface, as well as making access points to gaming kernel 300 controlled, where overall access is controlled using separate processes.

For example, game manager 304 parses an incoming command stream and, when a command dealing with I/O comes in (arrow 312), the command is sent to an applicable library routine 314. Library routine 314 decides what it needs from a device, and sends commands to I/O board server 310 (see arrow 316). A few specific drivers remain in operating system layer 308's kernel, shown as those below line 318. These are built-in, primitive, or privileged drivers that are (i) general (ii) kept to a minimum and (iii) are easier to leave than extract. In such cases, the low-level communications is handled within operating system layer 308 and the contents passed to library routines 314.

Thus, in a few cases library routines may interact with drivers inside operating system layer 308, which is why arrow 316 is shown as having three directions (between library routines 314 and I/O board server 310, or between library routines 314 and certain drivers in operating system layer 308). No matter which path is taken, the logic needed to work with each device is coded into modules in the user layer of the diagram. Operating board server 310 layer is kept as simple, stripped down, and common across as many hardware platforms as possible. The library utilities and user-level drivers change as dictated by the game cabinet or game machine in which it will run. Thus, each game cabinet or game machine may have an industry standard EGM processing board 202 connected to a unique, relatively dumb, and as inexpensive as possible I/O adapter board, plus a gaming kernel 300 which will have the game-machine-unique library routines and I/O board server 310 components needed to enable game applications to interact with the gaming machine cabinet. Note that these differences are invisible to the game application software with the exception of certain functional differences (i.e., if a gaming cabinet has stereo sound, the game application will be able make use of API 302 to use the capability over that of a cabinet having traditional monaural sound).

Game manager 304 provides an interface into game kernel 300, providing consistent, predictable, and backwards compatible calling methods, syntax, and capabilities by way of game application API 302. This enables the game developer to be free of dealing directly with the hardware, including the freedom to not have to deal with low-level drivers as well as the freedom to not have to program lower level managers 320, although lower level managers 320 may be accessible through game manager 304's interface if a programmer has the need. In addition to the freedom derived from not having to deal with the hardware level drivers and the freedom of having consistent, callable, object-oriented interfaces to software managers of those components (drivers), game manager 304 provides access to a set of upper level managers 324 also having the advantages of consistent callable, object-oriented interfaces, and further providing the types and kinds of base functionality required in casino-type games. Game manager 304, providing all the advantages of its consistent and richly functional game application API 302 as supported by the rest of game kernel 300, thus provides a game developer with a multitude of advantages.

Game manager 304 may have several objects within itself, including an initialization object (not shown). The initialization object performs the initialization of the entire game machine, including other objects, after game manager 304 has started its internal objects and servers in appropriate order. In order to carry out this function, the kernel's configuration manager 322 is among the first objects to be started; configuration manager 322 has data needed to initialize and correctly configure other objects or servers.

The upper level managers 324 of game kernel 300 may include game event log manager 326 which provides, at the least, a logging or logger base class, enabling other logging objects to be derived from this base object. The logger object is a generic logger; that is, it is not aware of the contents of logged messages and events. The game event log manager's 326 job is to log events in non-volatile event log space. The size of the space may be fixed, although the size of the logged event is typically not. When the event space or log space fills up, one embodiment will delete the oldest logged event (each logged event will have a time/date stamp, as well as other needed information such as length), providing space to record the new event. In this embodiment, the most recent events will thus be found in the log space, regardless of their relative importance. Further provided is the capability to read the stored logs for event review.

In accordance with one embodiment, meter manager 328 manages the various meters embodied in the game kernel 300. This includes the accounting information for the game machine and game play. There are hard meters (counters) and soft meters; the soft meters may be stored in non-volatile storage such as non-volatile battery-backed RAM to prevent loss. Further, a backup copy of the soft meters may be stored in a separate non-volatile storage such as EEPROM. In one embodiment, meter manager 328 receives its initialization data for the meters, during start-up, from configuration manager 322. While running, the cash in manager 330 and cash out manager 332 call the meter manager's 328 update functions to update the meters. Meter manager 328 will, on occasion, create backup copies of the soft meters by storing the soft meters' readings in EEPROM. This is accomplished by calling and using EEPROM manager 334.

In accordance with still other embodiments, progressive manager 336 manages progressive games playable from the game machine. Event manager 338 is generic, like game event log manager 326, and is used to manage various gaming machine events. Focus manager 340 correlates which process has control of various focus items. Tilt manager 342 is an object that receives a list of errors (if any) from configuration manager 322 at initialization, and during game play from processes, managers, drivers, etc. that may generate errors. Random number generator manager 344 is provided to allow easy programming access to a random number generator (RNG), as a RNG is required in virtually all casino-style (gambling) games. Random number generator manager 344 includes the capability of using multiple seeds.

In accordance with one or more embodiments, a credit manager object (not shown) manages the current state of credits (cash value or cash equivalent) in the game machine, including any available winnings, and further provides denomination conversion services. Cash out manager 332 has the responsibility of configuring and managing monetary output devices. During initialization, cash out manager 332, using data from configuration manager 322, sets the cash out devices correctly and selects any selectable cash out denominations. During play, a game application may post a cash out event through the event manager 338 (the same way all events are handled), and using a call back posted by cash out manager 332, cash out manager 332 is informed of the event. Cash out manager 332 updates the credit object, updates its state in non-volatile memory, and sends an appropriate control message to the device manager that corresponds to the dispensing device. As the device dispenses dispensable media, there will typically be event messages being sent back and forth between the device and cash out manager 332 until the dispensing finishes, after which cash out manager 332, having updated the credit manager and any other game state (such as some associated with meter manager 328) that needs to be updated for this set of actions, sends a cash out completion event to event manager 338 and to the game application thereby. Cash in manager 330 functions similarly to cash out manager 332, only controlling, interfacing with, and taking care of actions associated with cashing in events, cash in devices, and associated meters and crediting.

In a further example, in accordance with one or more embodiments, I/O board server 310 may write data to the gaming machine EEPROM memory, which is located in the gaming machine cabinet and holds meter storage that must be kept even in the event of power failure. Game manager 304 calls the I/O library functions to write data to the EEPROM. The I/O board server 310 receives the request and starts a low priority EEPROM manager 334 thread within I/O board server 310 to write the data. This thread uses a sequence of 8 bit command and data writes to the EEPROM device to write the appropriate data in the proper location within the device. Any errors detected will be sent as IPC messages to game manager 304. All of this processing is asynchronous.

In accordance with one embodiment, button module 346 within I/O board server 310, polls (or is sent) the state of buttons every 2 ms. These inputs are debounced by keeping a history of input samples. Certain sequences of samples are required to detect a button was pressed, in which case the I/O board server 310 sends an inter-process communication event to game manager 304 that a button was pressed or released. In some embodiments, the gaming machine may have intelligent distributed I/O which debounces the buttons, in which case button module 346 may be able to communicate with the remote intelligent button processor to get the button events and simply relay them to game manager 304 via IPC messages. In still another embodiment, the I/O library may be used for pay out requests from the game application. For example, hopper module 348 must start the hopper motor, constantly monitor the coin sensing lines of the hopper, debounce them, and send an IPC message to the game manager 304 when each coin is paid.

Further details, including disclosure of lower level fault handling and/or processing, are included in U.S. Pat. No. 7,351,151 issued Apr. 1, 2008 entitled “Gaming Board Set and Gaming Kernel for Game Cabinets” the disclosure of which is incorporated herein by explicit reference.

Referring to FIGS. 4A and B, an example of a gaming system 801 is shown in accordance with one or more embodiments. Gaming system 801 may include one casino or multiple locations (herein referred to collectively as a casino enterprise) and generally includes a network of gaming devices 803 (including gaming devices 10 of the type as described in FIG. 1), floor management system (SMS) 805, and casino management system (CMS) 807. SMS 805 may include load balancer 811, network services server 813, player tracking module 28, iView (PTM 28) content servers 815, certificate services server 817, floor radio dispatch receiver/transmitters (RDC) 819, floor transaction servers 821 and game engines 823 (where the gaming devices 803 operate server based or downloadable games), each of which may connect over network bus 825 to gaming devices 803. CMS 807 may include location tracking server 831, WRG RTCEM (William Ryan Group Real Time Customer Experience Management from William Ryan Group, Inc. of Sea Girt, N.J.) server 833, data warehouse server 835, player tracking server 837, biometric server 839, analysis services server 841, third party interface server 843, slot accounting server 845, floor accounting server 847, progressives server 849, promo control server 851, bonus game (such as Bally Live Rewards) server 853, download control server 855, player history database 857, configuration management server 859, browser manager 861, tournament engine server 863 connecting through bus 865 to server host 867 and gaming devices 803. The various servers and gaming devices 803 may connect to the network with various conventional network connections (such as, for example, USB, serial, parallel, RS485, Ethernet). Additional servers which may be incorporated with CMS 807 include a responsible gaming limit server (not shown), advertisement server (not shown), and a control station server (not shown) where an operator or authorized personnel may select options and input new programming to adjust each of the respective servers and gaming devices 803. SMS 805 may also have additional servers including a control station (not shown) through which authorized personnel may select options, modify programming, and obtain reports of the connected servers and devices, and obtain reports. The various CMS and SMS servers are descriptively entitled to reflect the functional executable programming stored thereon and the nature of databases maintained and utilized in performing their respective functions.

The gaming devices 803 include various peripheral components that may be connected with USB, serial, parallel, RS-485 or Ethernet devices/architectures to the system components within the respective gaming machine. The GMU 507 (shown as GMU 206 in FIG. 2A) has a connection to the base game through a serial SAS connection. The system components in the gaming cabinet may be connected to the servers using HTTPs or G2S protocols over Ethernet. Using CMS 807 and/or SMS 805 servers and devices, firmware, media, operating systems, and configurations may be downloaded to the system components of respective gaming devices for upgrading or managing floor content and offerings in accordance with operator selections or automatically depending upon CMS 807 and SMS 805 master programming The data and programming updates to gaming devices 803 are authenticated using conventional techniques prior to install on the system components.

In various embodiments, any of the gaming devices 803 may be a mechanical reel spinning slot machine, video slot machine, video poker machine, video Bingo machine, Keno machine, or a gaming device offering one or more of the above described games including an interactive wheel feature. Alternately, gaming devices 803 may provide a game with an accumulation-style feature game as one of a set of multiple primary games selected for play by a random number generator, as described above. A gaming system 801 of the type described above also allows a plurality of games in accordance with the various embodiments of the invention to be linked under the control of a group game server (not shown) for cooperative or competitive play in a particular area, carousel, casino or between casinos located in geographically separate areas. For example, one or more examples of group games under control of a group game server are disclosed in U.S. Published Application 2008/0139305, entitled “Networked System and Method for Group Gaming,” filed on Nov. 9, 2007, which is hereby incorporated by reference in its entirety for all purposes.

The gaming system 801, among other functionalities such as slot accounting (i.e. monitoring the amount wagered (“drop”), awards paid) and other casino services, includes the player tracking CMS/CMP server 837 and/or data warehouse 835 storing player account data. This data includes personal data for players enrolled in the casino players club sometimes referred to as a loyalty club. An example of the personal data is the player's name, address, SSN, birth date, spouse's name and perhaps personal preferences such as types of games, preferences regarding promotions, player rating level, available player comp points (points accumulated based upon commercial “spend” activity with the enterprise including gaming and which may be redeemed or converted into cash or merchandise) and the like. As is known in the industry and according to the prior art, at enrolment the player is assigned a created account in the player tracking CMS/CMP server 837 and is issued a player tracking card having a machine readable magnetic stripe.

The system 801 may also include electronic transfer of funds functionality. For example, a player having accumulated $100 at a gaming terminal 10 may decide to “cash out” to play another gaming terminal 10. The player, for example using the PTM 28 to initiate communication with the system 801 for example server 837 to upload the value from the gaming terminal 10 into an electronic account associated with the player's account. The player may choose to upload all or a portion of the funds the player's established electronic account. The system would prompt the player to enter their PIN (or obtain biometrical confirmation as to the player's identity) and upload the chosen amount to their account. When the player moves to another gaming terminal 10 he/she inserts their player loyalty card into the card reader 32 to access their account. A prompt provides for the player to request funds from their account. Entering their PIN (or biometric identifier) the player can input the desired amount which is downloaded to their gaming terminal 10 for play.

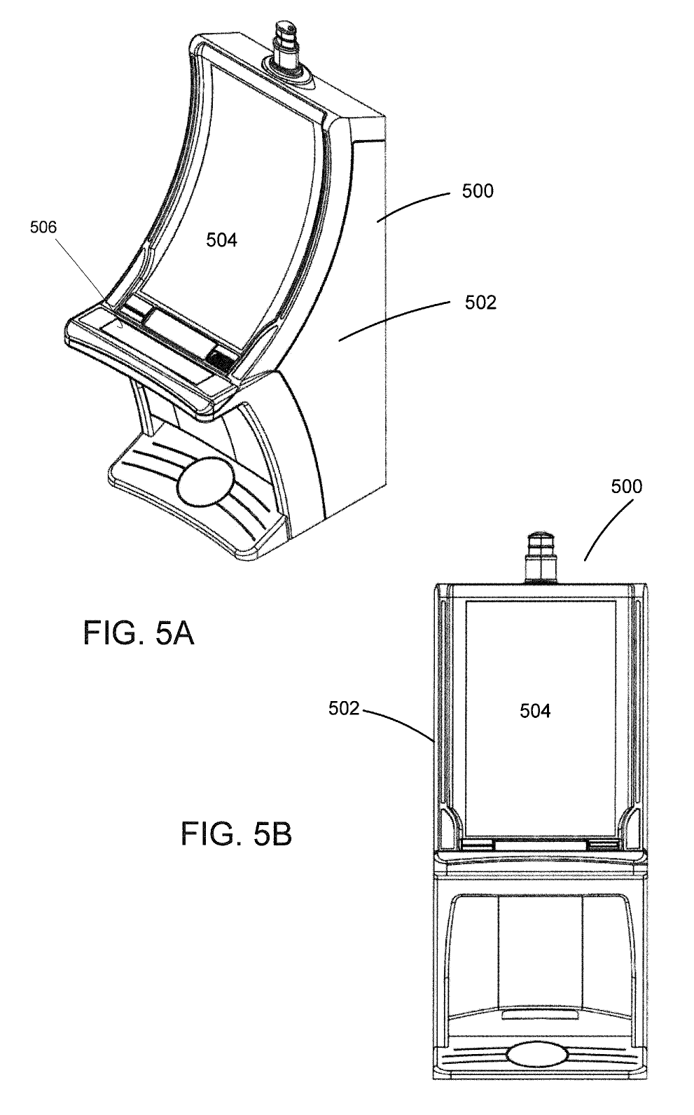

Turning the FIGS. 5A and 5B there is a shown a gaming device 500 adapted for the various features of the present invention. The gaming device 500 includes a cabinet 502 supporting a large format, curved primary video display 504 and a video, touch input button panel 506 of the type described above. The primary video display 504 is a continuous, curved LCD display larger than the aforesaid legacy primary and secondary displays 14, 18 and is arranged in a portrait mode. For example the curved LCD primary video display 504 may have a long dimension (arc length) of 40 inches and a width of 18 inches.

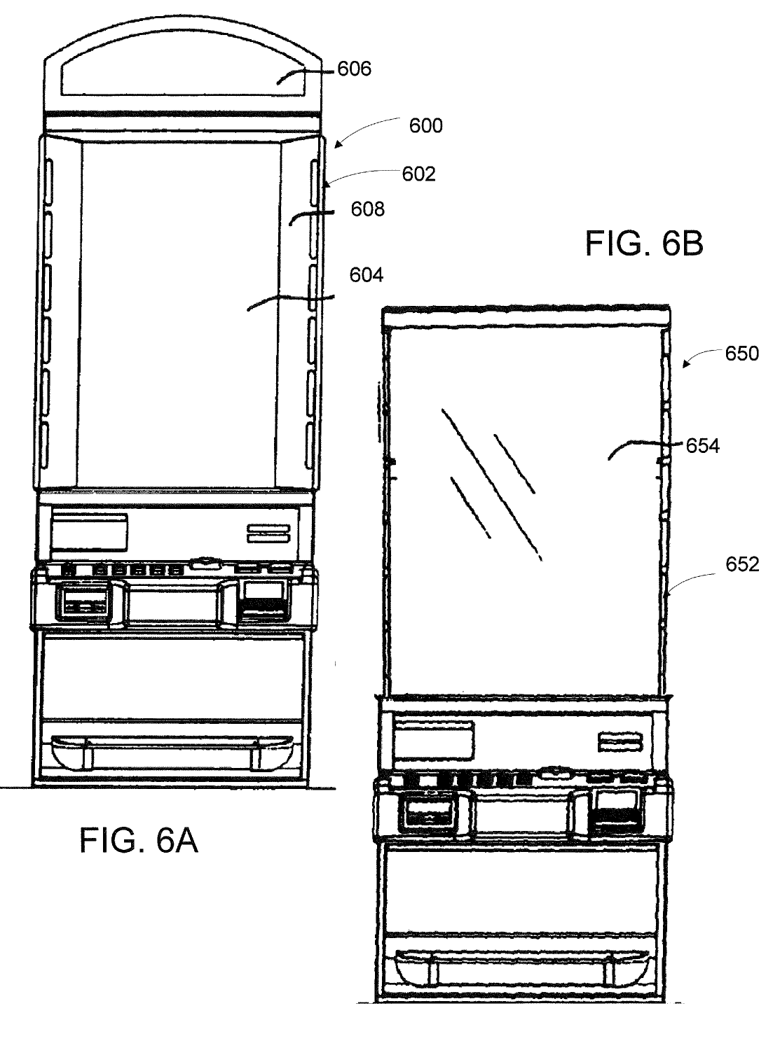

FIGS. 6A illustrates another version of a gaming device 600 including a cabinet 602 supporting a large format, continuous flat screen LCD primary video display 604. The large format primary video display 604 is larger in dimension that the legacy primary game display 14 and legacy video secondary display 18 and is arranged in a portrait mode. The large format primary video display may have dimensions of 40×18 inches. A backlit topper 606 as well a decorative molding 608 may also be provided. FIG. 6B shows another version of a gaming device 650 having a cabinet 652 supporting a large format, flat screen LCD primary video display 654. Again in an embodiment the large format primary video display 654 is arranged in the portrait mode and may be a 40 inch×18 inch display.

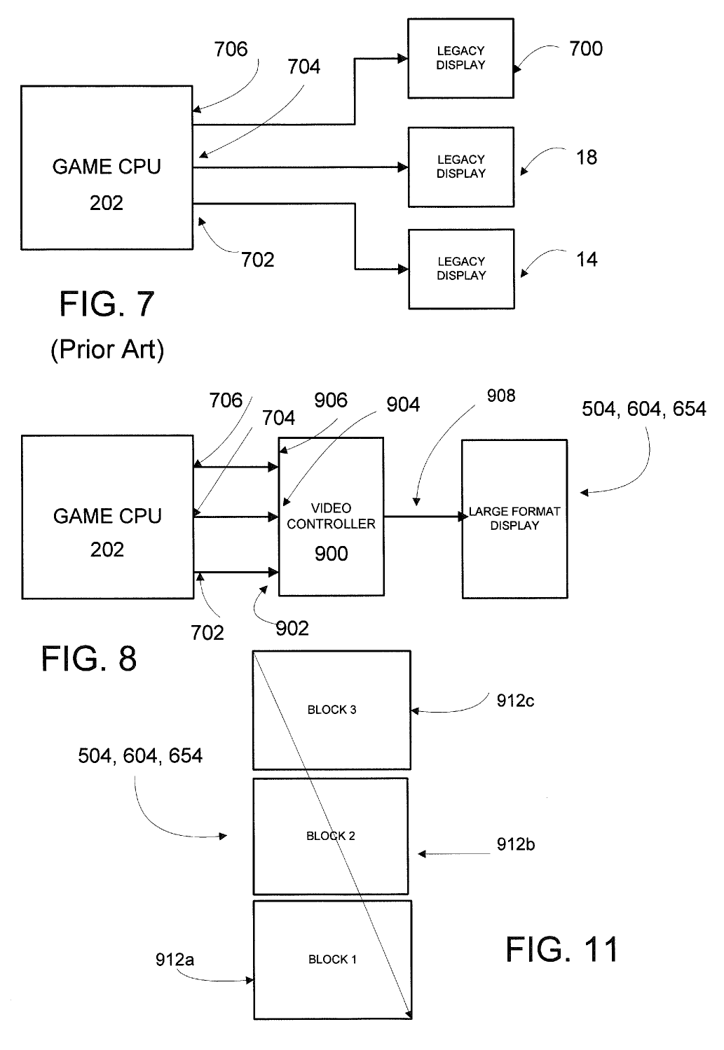

FIG. 7 illustrates the connections between the game processor CPU, e.g. EGM processor board 202 and the plural legacy video content displays such as the legacy primary game display 14, legacy secondary display 18 and, in this example, a tertiary legacy content video display 700 according to the prior art. The processor board 202 has a legacy primary display output 702, a legacy secondary display output 704 and a legacy tertiary display output 706. These outputs, according to the prior art, output, respectively, the designed primary game video content, secondary display video content and tertiary display video content.

FIG. 8 illustrates, in comparison to FIG. 7, the arrangement according to the present invention. In this embodiment the gaming device, such as gaming device 500, 600, 650 includes a video controller 900 functionally interposed between the legacy game processer 202 and a large format video display of the type such as primary video displays 504, 604 and 654. The video controller 900 has primary display input 902, secondary display input 904 and tertiary display input 906 each adapted to receive the corresponding primary display output 702, a secondary display output 704 and a tertiary display output 706. A video controller output 908, such as a wired cable harness, is connected to the primary video display 504. 604, 654 to provide video content thereto.

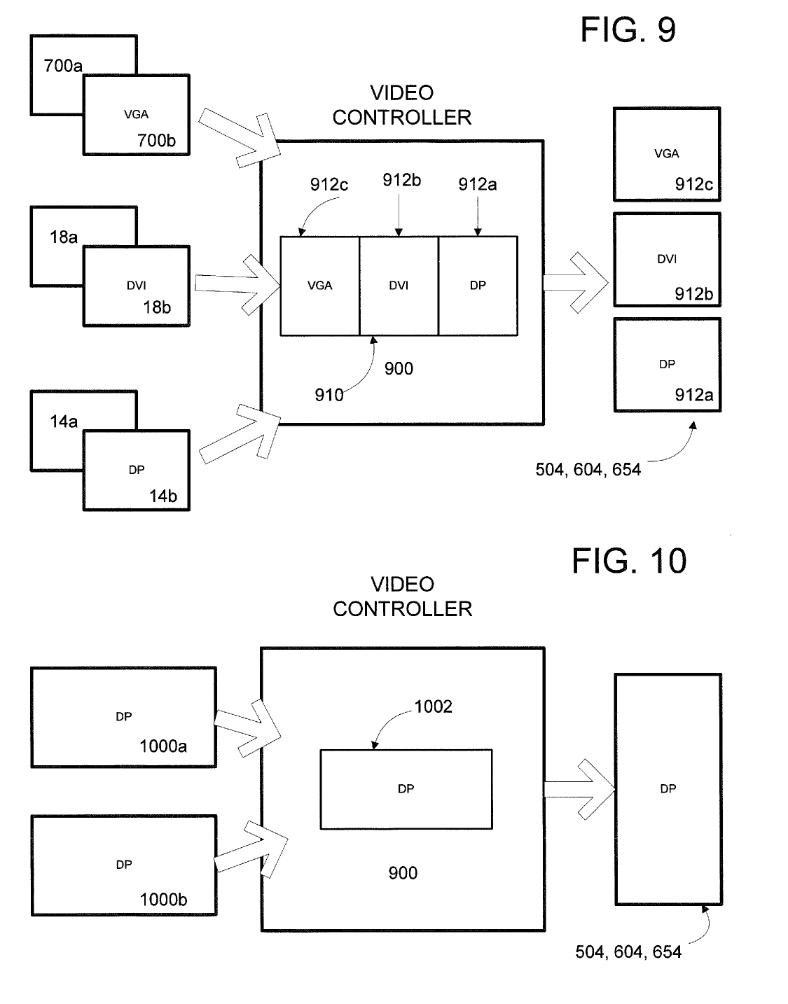

The video controller 900 is configured to process both natively developed video content intended for presentation at the large format video display as well as legacy video content developed for presentation at plural displays as described above. FIG. 9 illustrates the operation of the video controller 900 concerning the aforesaid legacy video content developed for display at plural displays. As an illustrative example, the video content legacy primary video display 14a or 14 b may be adapted to fit a small video display, e.g. 14 inch or 17 inch video display, where display 14a is a 1360×768 P (pixel) display or where display 14b is a 1920×1080 P. The video format of the content provided to either legacy video content primary display 14a, b may be a DP (Display Port) format. The video content input signals provided by the legacy game processer 202 to either legacy primary game display 14a, b is output to the video controller 900. The video content legacy secondary display 18a or 18b is also adapted to fit a small video display, e.g. 14 inch or 17 inch video display and may be formatted to either 1360×768 P or 1920×1080 P, for example. The video format of the content provided to either type of legacy video content secondary display 18a, b may be a DVI. The video content input signals provided by the legacy game processer 202 to either legacy secondary display 18a, b is output to the video controller 900. The video content for the tertiary display 700a, b is also adapted to fit a small video display, e.g. 14 inch or 17 inch video display and may be formatted to either 1360×768 P or 1920×1080 P, for example. The video format of the content provided to either legacy video content tertiary display 700a, b may be a VGA. The video content input signals provided by the legacy game processer 202 to either legacy secondary display 18a, b is output to the video controller 900. The video controller 900 includes a processor controller programmed to block, rotate, scale and nest the video content from the game processor. By blocking, the video controller places the video content which would have been provided to the plural legacy video displays of a legacy device in a blocked mosaic 910 as suggested in FIG. 9 wherein each “block” is assigned to a video content stream and the mosaic 910 may be oriented horizontally. The primary video content for the game and coming from the primary game input 702, is assigned to a 1080×640 P block 912a in the mosaic 910. The secondary video content coming from the secondary input 704 is assigned to a 1080×640 P block 912b. The tertiary video content coming from the tertiary input 706 is assigned to a 1080×640 P block 912c. The video controller 900 is also programmed and configured to scale each block 912a-c to a pixel size of 1056×594P and to rotate the mosaic 910 to a vertical orientation to be arranged and sized to fit the large format video display 504. 604, 654 to provide the legacy video content thereto. Blanked margins (not shown) at the top and bottom (vertical 45 P) and between blocks 912a and 912b and 912c and 912c (vertical 24 P) which may display as black borders serve to fill the 1056×1920P large format primary video display 504, 604, 654.

It should be noted that the video controller 900 is configured to determine from the outputs 702, 704, 706 connected to its inputs 902, 904, 906 that the aforesaid blocking, scaling and rotation is required. Further, if the legacy content was developed for only two legacy video displays, the video controller 900 is configured to make the determination and process the video content accordingly such as by only creating two blocks in the mosaic. If there are more than three outputs 702, 704, 706 then the video controller may be provided with more than three inputs 902, 904, 906. For example where there is a virtual button deck of the type described above, the video controller 900 may be configured to block into the mosaic 910 a block (not shown) for the virtual button deck such the same may be displayed at the large format primary display 504, 604, 654 such as below block 912a.

The primary game output and input 702, 902 as discussed above are configured to provide primary game content. The video controller 900 is configured to position this content block 912a at a primary game position in the large format video primary display 504, 604, 654 to coincide with player interaction and touch screen functionality. For example touch screen functionality may only be associated with those areas accommodating the blocks 912a or 912b since they are within reach of the player.

The legacy video content may be in formats other than DP, DVI or VGA such as HDMI, SVGA, XGA, SXGA, UXGA or other video content formats. Further the legacy video content may be of the same format for each of the legacy displays, e.g. all in a DVI format.

The video controller 900 is also configured to process native video content, i.e. video content originally developed for display on the large format video primary display 504, 604, 654 as shown in FIG. 10. For example the native content may be crafted for either a 1360×768 P video display 1000a or a 1920×1080 P large format video display 1000b. The large format video display may be a curved or flat screen large format primary video display 504, 604, 654 described above. The display format may be as described above; but in this example is shown as in a DP format. The video controller accepts the video content from the EGM processor board 202 or other processor primary game output such as primary output 702 and blocks the content into a 1920×1080 P block 1002, if necessary. Recall that some native video content may already be in the 1920×1080 P format. The block 1002 is rotated and, if required, scaled to fit the 1056×1920 P format of the large format video primary display 504, 604, 654. The video controller is configured to interpret a single input connection from the EGM processor board 202 (or other intervening or cooperative processor) as native video content for performance of the steps recited above.

Turning to FIG. 11 another example of the output of the video controller is described. In this embodiment the large format video primary display 504, 604, 654 has a diagonal dimension 1100 of, for example, 40 inches. Blocks 1, 2 and 3 (912a, b, c) would be in display formats of DP, DVI and VGA, respectively (as described above) and be 1080×640 P.

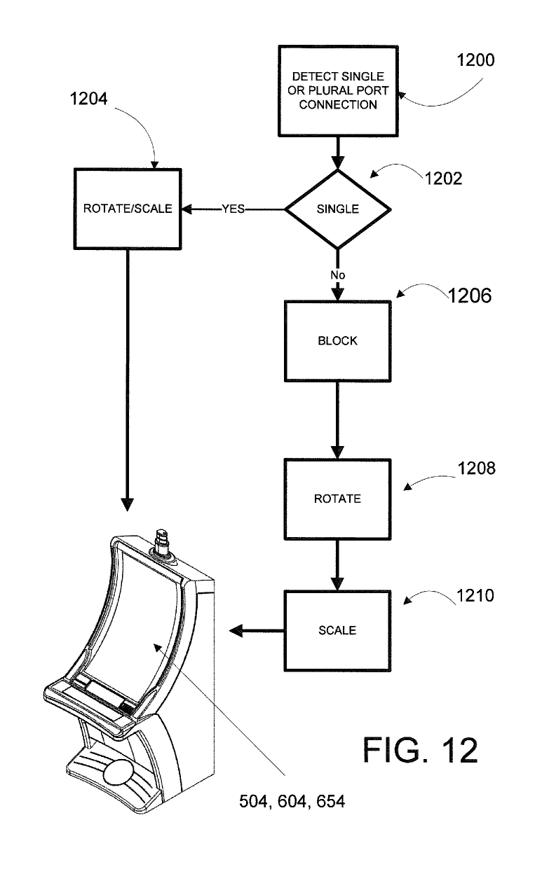

FIG. 12 is a logic diagram for an embodiment of the video controller 900 processor operation. At 1200 the video controller 900 processor detects single or plural connections at its inputs 902, 904, 906. If a single connection is detected at 1202 (for example a connection only at the primary input 902) the video controller 900 interprets this as providing native content and at 1204 basically rotates and scales (if necessary) the blocked video content as described with reference to FIG. 10. The rotated and scaled video content is then provided to the large format video primary display 504, 604, 654. If at 1202 plural connections are detected the video controller 900 interprets this occurrence as providing video content which was originally intended for a multi-display game device (legacy video content) and at 1206, 1208 and 1210 blocks, rotates and scales the video content in the manner described with reference to FIG. 9. The mosaic created by the video controller 900 is provided to the large format video primary display 504, 604, 654.

Where system delivered content is intended to be mixed into the mosaic 910 such as described in Kelly, et al, U.S. Pat. No. 8,241,123 the disclosure of which has been incorporated by reference, the video switcher and touch routing device would be disposed between the game processor (e.g. EGM processor board 202) and the video controller 900.

While the EGM processor board 202 is described as the processor for configuring gaming device video content for display it should be understood that multiple processors could be used to select and present the video content described herein. Further the video controller 900 may include one or several processors programmed (firmware and/or software) to operate as described.

The foregoing description, for purposes of explanation, uses specific nomenclature and formula to provide a thorough understanding of the invention. It should be apparent to those of skill in the art that the specific details are not required in order to practice the invention. The embodiments have been chosen and described to best explain the principles of the invention and its practical application, thereby enabling others of skill in the art to utilize the invention, and various embodiments with various modifications as are suited to the particular use contemplated. Thus, the foregoing disclosure is not intended to be exhaustive or to limit the invention to the precise forms disclosed, and those of skill in the art recognize that many modifications and variations are possible in view of the above teachings.

What is claimed is:

1. A gaming machine having a primary video display for displaying (i) native graphics content configured to be presented at said primary video display and (ii) legacy graphics content scaled to be cooperatively presented at plural legacy video displays of sizes different than said primary display, said gaming machine comprising:
a processor to process software defining one of (a) said native graphics content for display at the primary video display and (b) said legacy graphics content for display at said plural legacy displays, said processor having multiple outputs each configured to provide video content to a display; and
a video controller including plural inputs connections from said processor and an output connection to said primary video, said video controller configured to interpret plural input connections as providing said legacy graphics content and to at least scale said legacy content to create a legacy content mosaic to fit said legacy content to said primary video display.

2. The gaming machine of claim 2 comprising said video controller configured to block, rotate, scale and nest said legacy graphics content to create said mosaic.

3. The gaming machine of claim 1 wherein said primary video display is a video display arranged in a portrait mode.

4. The gaming machine of claim 1 comprising said primary display is a concave curved display.

5. The gaming machine of claim 1 wherein said legacy graphics content is configured to be displayed on three vertically arranged legacy video displays each smaller than said primary display, said video controller including three input connections each configured to receive a processor output corresponding to a legacy video display and said video controller is configured to interpret said plural input connections as providing said legacy graphics content and to at least scale said content to create said mosaic.

6. The gaming machine of claim 1 comprising said video controller is configured interpret a singular input connection as providing said native graphics content.

7. The gaming machine if claim 1 comprising one of said inputs defining a primary input to receive primary content directed to a legacy primary display and said video controller configured to at least scale said legacy content to create said legacy content mosaic wherein said primary content is assigned to a primary display location in said primary display.

8. The gaming machine of claim 7 comprising said primary display location in said primary display includes a touch screen interface.

9. A gaming machine having a primary video display for displaying (i) native graphics content configured to be presented at said primary video display and (ii) legacy graphics content scaled to be cooperatively presented at plural legacy video displays of sizes different than said primary display, said gaming machine comprising:
a processor to process software defining one of (a) said native graphics content for display at the primary video display and (b) said legacy graphics content for display at said plural legacy displays, said processor having multiple outputs each configured to provide video content to a display; and
a video controller including plural inputs connections from said processor and an output connection to said primary video, said video controller configured to (i) interpret a singular input connection from said processor as providing native graphics content and to provide a first scaling to fit said content to said primary display and (ii) plural input connections as providing said legacy graphics content and to at least scale and position said legacy graphics content to create a composite legacy graphics content mosaic to fit said legacy content to said primary video display.

10. The gaming machine of claim 9 comprising said primary display is arranged in a portrait mode.

11. The gaming machine if claim 9 comprising one of said inputs defining a primary input to receive primary content designated for display at a legacy primary display and said video controller configured to at least scale and position said legacy content to create said legacy content mosaic wherein said primary content is assigned to a primary display location in said primary display.

12. A video controller for a gaming machine having (a) a primary video display for displaying (i) native graphics content configured to be presented at said primary video display and (ii) legacy graphics content scaled to be cooperatively presented at plural legacy video displays of sizes different than said primary display and a processor controlling the rendering of said content and having plural outputs for providing said rendered content to a display for presentation thereof, said video controller comprising:
plural inputs each for receiving an output from said processor;
a controller programmed for interpreting a singular input connection as providing said native graphics content configured for display at said primary display and plural input connections as providing legacy graphic content for display at said primary display; and
said controller further programmed to, upon interpretation of provision of said legacy graphic content, scale and arrange said legacy content to define a mosaic of said legacy graphics content fit on said primary video display.

13. The video controller of claim 12 comprising said controller programmed to, upon interpretation of provision of said native content to provide, if necessary, apply a first scaling to said native content to fit said native content to said primary video display and upon interpretation of provision of said legacy graphic content apply a second scaling and arrange said legacy content to define said mosaic.

14. The video controller of claim 12 wherein said primary video display is arranged in a portrait mode, said video controller comprising said controller is programmed to, upon interpretation of provision of said legacy graphic content, block said content into plural adjacent fields, scale and nest said fields to define said mosaic.

15. The video controller of claim 12 comprising designating one of the inputs as a primary input, said controller programmed to position in said primary video display content provided to said primary input in a display primary position.

16. The video controller of claim 12 wherein said legacy graphics includes primary game content graphics intended to be displayed at a legacy gaming machine primary display and secondary game content graphics intended to be displayed at a second legacy display, said video controller comprising a controller having a primary content input port to receive said primary game content graphics and a secondary content input port to receive said secondary game content graphics, said controller programmed to position said primary game content graphics to a primary display position in said primary video display and said secondary game content graphics to a secondary position in said primary video display.

17. A method for providing one of natively developed game content and legacy game content at a gaming machine primary video display where said legacy game content is configured to provide game content graphics to a legacy primary video display and separate legacy secondary video display and where the legacy video displays are smaller than the primary video display, said method comprising:
providing a video controller for receiving at one or plural input ports graphic content signals from a game processor and for delivering graphic content signals to said primary video display; and
interpreting at said controller graphic content signals delivered at plural input ports as representing legacy primary and secondary video content; and
at least scaling said legacy primary and secondary video content to define a mosaic of adjacent legacy primary and secondary video content to fit into said primary video display.

18. The method of claim 17 comprising providing said primary video content to a primary video controller port and said secondary video content at another port and assigning to a primary display position designated in said primary display video content provided to said primary video controller port.

19. The method of claim 17 wherein the primary display is one of a curved or flat video display arranged in a portrait mode, said method comprising blocking, scaling, rotating and nesting said legacy primary and secondary video content to define said mosaic.
